(19) United States
(12) Patent Application Publication
(10) Pub. No.: US 2004/0057507 A1
(43) Pub. Date: Mar. 25, 2004

(54) Link estimation in a communication system

(76) Inventors: Ron Rotstein, Arlington Heights, IL (US); Randy L. Ekl, Lake Zurich, IL (US); Mark J. Johnson, Cary, IL (US)

Correspondence Address: MOTOROLA, INC., 1303 EAST ALGONQUIN ROAD, IL01/3RD, SCHAUMBURG, IL, 60196

(21) Appl. No.: 10/253,298

(22) Filed: Sep. 24, 2002

(51) Int. Cl. H04L 5/16

(52) U.S. Cl. 375/219; 375/222

(57) ABSTRACT

A first device (102/104) receives a first message (300) from a second device (104/102) over a communication link (106). The first device also receives a first transmit power level (202/212) by which the first message was transmitted and a first interference level (204/208) as perceived by the second device. The first device calculates at least one transmission parameter by which a second message will be transmitted to the second device based on the first transmit power level and the first interference level.

### FIELD OF THE INVENTION

The present invention relates generally to improved link estimation in a wireless or wired communication system, for example, a wireless local area network system.

### BACKGROUND OF THE INVENTION

Referring to FIG. 1, in a typical wireless local area network (“WLAN”) system 100, an access point (“AP”; i.e., infrastructure device) 102 transmits messages to a plurality of mobile stations (“MS”; i.e., subscriber station) 104. A typical MS 104 receives a message over a communication link 106, uses the information contained in the message to identify the AP 102, and processes the message in a conventional manner as known in the art. There are, however, a few problems with the current method.

First, if transmit power control is used, a power control message needs to be transmitted at maximal power. Second, the power control message does not provide a method of fully evaluating the communication link; assuming that there are multiple APs with different peak power outputs, and that the MS has yet a different power output from the different APs, there is no way for the MS to evaluate which link is better and how much power to use for the uplink power. Third, due to the time division multiplexing nature of the channel, there is no immediate link quality indication, such as the quality indicator channel that exists in the various data oriented cellular standards. Fourth, lacking immediate channel knowledge, the MS transmit power control and adaptive modulation and coding are sub-optimal, especially in outdoor application where the channel changes with time (e.g., reflections from a moving car may change the channel even if both AP and MS are stationary).

Thus, there exists a need for improved link estimation in a communication system.

### BRIEF DESCRIPTION OF THE FIGURES

A preferred embodiment of the invention is now described, by way of example only, with reference to the accompanying figures in which:

FIG. 1 illustrates a typical wireless local area network (“WLAN”) system diagram;

FIG. 2 illustrates the typical WLAN system of FIG. 1 with added power and interference levels in accordance with the present invention;

FIG. 3 illustrates a message format in accordance with the present invention;

FIG. 4 illustrates a sequence diagram of communications between an access point and a mobile station in accordance with the present invention;

FIG. 5 illustrates a block diagram of a receiver in accordance with the present invention; and

FIG. 6 illustrates a plot of power versus time for the input data to the receiver of FIG. 5 in accordance with the present invention.

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

The present invention uses measurements at both ends of the communication link 106 to allow the transmitting device to more accurately predict the channel conditions, and use the measurements, in whole or in part, for link estimation, transmit power control and adaptive modulation and coding.

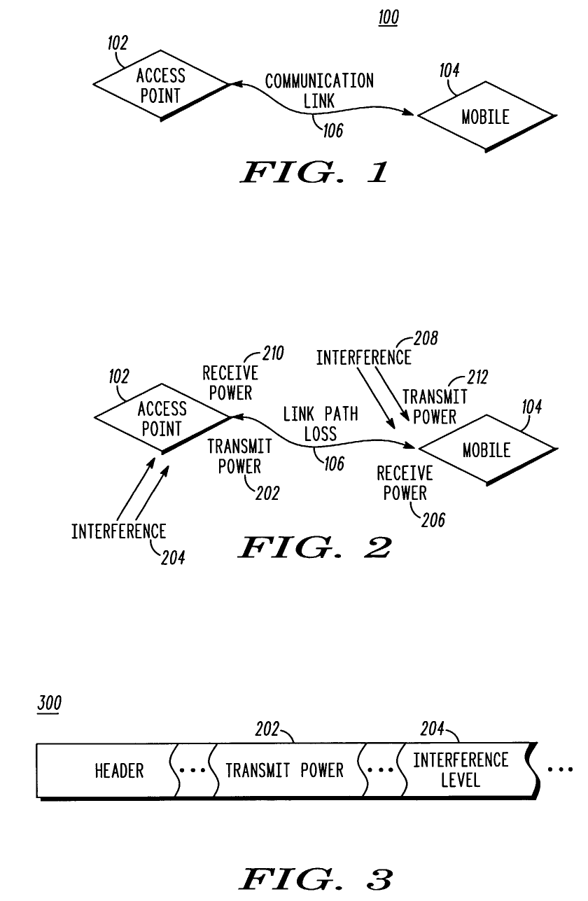

FIG. 2 illustrates a typical WLAN system 100 as previously described with respect to FIG. 1. As noted in the preceding discussion of FIG. 1, preferably both the AP 102 and the MS 104 have the capabilities to act as a transmitting device and a receiving device. For ease of explanation, the following description assumes that the AP 102 will first act as the transmitting device and the MS 104 will first act as the receiving device.

In the preferred embodiment, after participating devices have registered with the system, preferably all the participating devices enter into a quiet period where each device estimates/measures its local interference level. The interference level 204 is perceived at the AP 102, and the interference level 208 is perceived at the MS 104. Typically, the devices monitor the communication link 106 to identify the quiet period, however, the quiet period can, in addition to or alternatively, be scheduled at predetermined times or randomly by a device.

After at least the AP 102 has estimated its perceived local interference level 204, the AP 102 generates and/or prepares a message by defining a transmit power level 202 at which the message will be sent to the MS 104. Preferably, as illustrated in FIG. 3, the AP 102 inserts an indication of the transmit power level 202 used by the AP 102 and an indication of the interference level 204 as perceived locally by the AP 102 into the message 300, and transmits the message 300 to the MS 104. It should be noted that the transmit power level 202 and the interference level 204 can be communicated to the MS 104 in a single message (such as message 300) or a plurality of messages depending the system design parameters.

The MS 104 receives the message 300 at a given power 206, which may be different than the transmit power level 202 used by the AP 102 to transmit the message 300 over the communication link 106. Upon receipt of the message 300, the MS 104 identifies, from the message 300, the transmit power level 202 used by the AP 102 to transmit the message 300 and the interference level 204 perceived locally by the AP 102. Based on the transmit power level 202 used by the AP 102, the receive power level 206, the interference level perceived by the AP 102, and the interference level 208 perceived locally by the MS 104, the MS 104 deduces the “link path loss” and calculates at least one optimal transmission parameter (e.g., a transmit power level, a data rate, a modulation format, a modulation mode, error correction, spreading, coding, etc.) by which a response message will be transmitted to the AP 102. It is important to note that the transmit power level 202 used by the AP to transmit the message 300 is not necessarily the same as the receive power level 206 as received by the MS 104; moreover, the interference level 204 perceived locally by the AP 102 is not necessarily the same as the interference level 208 perceived locally by the MS 104.

As stated above, both the AP 102 and the MS 104 have the capabilities of acting as a transmitting device and a receiving device. After the MS 104 receives the message(s) from the AP 102 identifying the transmit power level 202 used to the transmit the message and the interference level 204 perceived locally by the AP 102, the two devices may switch roles and the MS 104 becomes the transmitting device an the AP 102 becomes the receiving device. Once the MS 104 generates and/or prepares the response message, the MS 104 transmits the response message to the AP 102 using at least one optimal transmission parameter (preferably, both the optimal transmit power level and optimal data rate).

The MS 104 informs the AP 102 of the transmit power level 212 it used to transmit the response message and the interference level 208 as perceived locally by the MS 104. As noted above, the transmit power level 212 and the interference level 208 can be communicated to the AP 102 in a single message (such as the response message) or a plurality of messages depending the system design parameters.

The AP 102 receives the response message at a given power 210, which may be different than the transmit power level 212 used by the MS 104 to transmit the response message over the communication link 106. Upon receipt of the response message, the AP 102 identifies the transmit power level 212 used by the MS 104 to transmit the response message, and the interference level 208 perceived locally by the MS 104 from the response message. Based on the transmit power level 212 used by the MS 104, the receive power level 210, the interference level 208 perceived locally by the MS 104, and the interference level 204 perceived locally by the AP 102, the AP 102 deduces the “link path loss” and calculates at least one optimal transmission parameter (e.g., a transmit power level, a data rate, a modulation format, a modulation mode, error correction, spreading, coding, etc.) by which a subsequent message will be transmitted to the MS 104. It is important to note that the transmit power level 212 used by the MS 104 to transmit the response message is not necessarily the same as the receive power level 210 as received by the AP 102; moreover, the interference level 208 perceived locally by the MS 104 is not necessarily the same as the interference level 204 perceived locally by the AP 102.

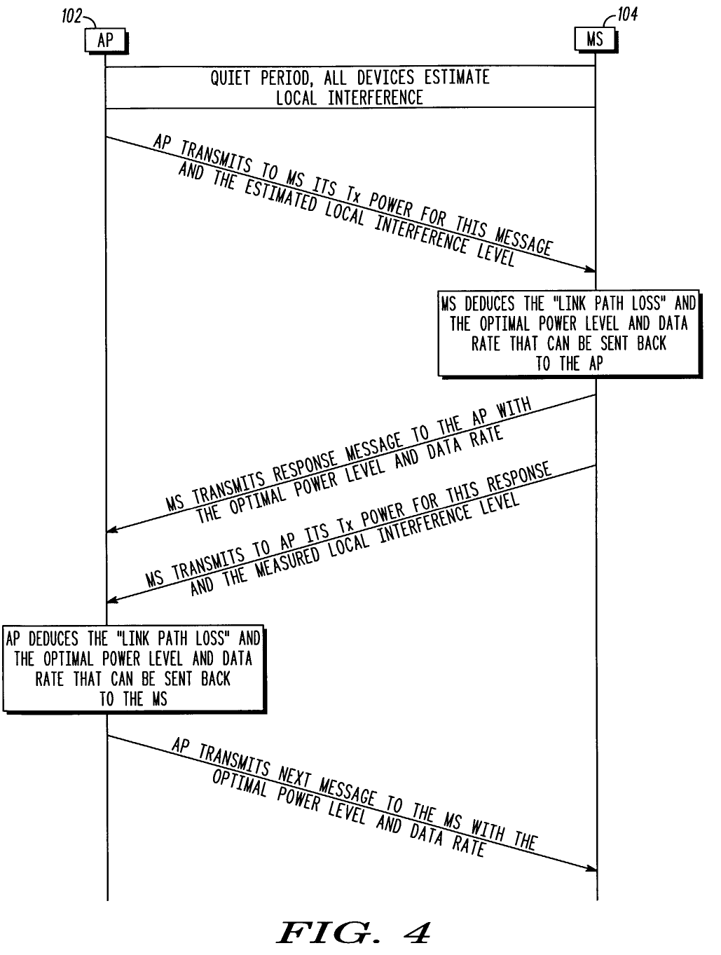

The process described above is an iterative process with the devices 102, 104 switching roles as the transmitting device and the receiving device; more importantly, messaging information extracted from a message(s) received when acting as a receiving device is used to facilitate the transmission of a message(s) transmitted when acting as a transmitting device. For ease of understanding, FIG. 4 pictorially illustrates the above process in a sequence diagram.

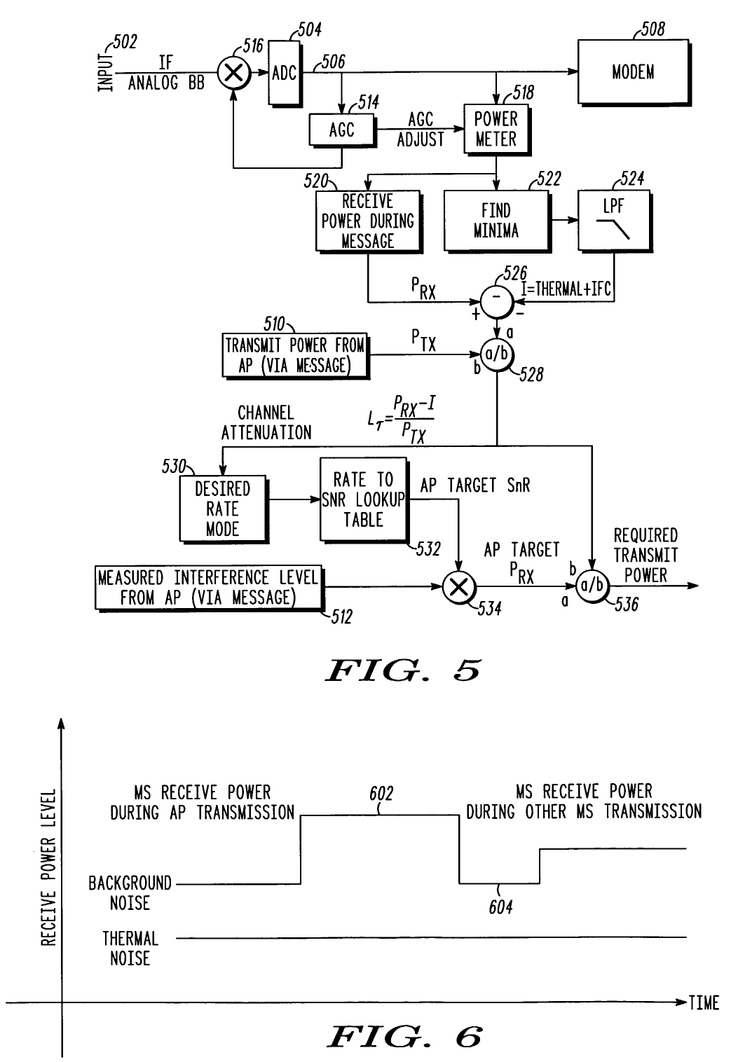

To elaborate further as to how the receiving device processes messages, let us now refer to FIG. 5. FIG. 5 illustrates a block diagram of a receiver 500 in accordance with the present invention. The receiver 500 resides on both the AP 102 and the MS 104 since both devices are capable of acting as a receiving device; as above, the following assumes that the MS 104 first acts as the receiving device. In operation, input 502 is received by an analog-to-digital converter (“ADC”) 504 and converted into digital signals 506. The digital signals 506 are then fed into a modem 508 that demodulates the digital signals 506 and transfers them to a host computer (not shown). In the preferred embodiment, the modem 508 further extracts messaging information (e.g., transmit power level 202 and local interference level 208) inserted into the message by the AP (currently acting as a transmitting device) 102 from the digital signals 506 and stores the transmit power level 202 as defined by the AP 102 into a first storage medium 510 and stores the interference level 208 as perceived locally by the AP 102 into a second storage medium 512.

Typically, the digital signals 506 are further used by an automatic gain control (“AGC”) circuit 514 to maintain constant signal energy at the output of the ADC 504 with the help of an analog multiplier 516 located in the radio frequency path. A power meter 518 measures the energy on the digital signals 506 and receives an AGC adjustment from the AGC 514 to calculate the power of the input 502 as illustrated in FIG. 6 in accordance with the present invention. Unless otherwise noted, all operations described herein use linear calculations rather than logarithmic calculation.

Once the power meter 518 has estimated the receive power 206 as perceived by the MS 104, the estimated receive power 206 is stored into a third storage medium 520 if the MS 104 receives a message (such as message 300) that contains the transmit power 202 used by the AP 102 to transmit message(s) and the interference level 204 as perceived locally by the AP 102. The content of the third storage medium 520 is illustrated in FIG. 6 as power level 602. If the MS 104 does not receive a message(s) that contains the transmit power 202 used to transmit message(s) by the AP 102 and the interference level 204 perceived locally by the AP 102, a processor 522 searches for a minima of the received power 206, and stores the minima in the fourth storage medium 522; the content of the fourth storage medium 522 is illustrated in FIG. 6 as power level 604. The content of the fourth storage medium 522 tends to be noisy, and is thus fed into a low pass filer (“LPF”) 524 to reduce the noise component.

Subtractor 526 subtracts the output of the LPF 524 (which is the total background noise) from the content from the third storage medium 520 (which is the estimated receive power 206 as perceived by the MS 104). A first divider 528 divides the output of subtractor 526 by the contents of the first storage medium 510. The output of the first divider 528 is the total channel attenuation of the communication link 106.

Processor 530 computes a desired rate and modulation mode that needs to be applied to the response message based on the total channel attenuation of the communication link 106; in the preferred embodiment, as noted above, the response message is the message that the MS 104 will eventually transmit to the AP 102. The calculated desired rate and modulation mode is fed into processor 532 that calculates the signal-to-noise ratio (“SNR”) required by the AP 102 to successfully receive/decode the response message that will be eventually transmitted by the MS 104. Multiplier 534 multiplies the output of the processor 532 with the content of the second storage medium 512 (which is the interference level 204 perceived locally at the AP 102). The output of the multiplier 534 produces the desired receive power level in which the AP 102 should receive the response message. A divider 536 divides the desired receive power level in which the AP 102 should receive the response message 210 by the total channel attenuation to produce a minimum transmit power level 212 in which the MS 104 should apply when transmitting the response message in order to compensate for “link path loss” and local interference 204 as perceived by the AP 102.

The receiver performs in the same manner on the AP 102 when the AP 102 is acting as the receiving device.

The receiver process described in FIG. 5 is further detailed by the following mathematical analysis.

When the power meter 518 receives the digital signals 506, the power meter 518 estimates the total received power 206 at the MS 104. This estimated received power 206 could be expressed as:

P_{RX}=P_{Tx}×L_{P}+I_{MP}+I_{OC}+N₀

where:

P_{Rx} is the total estimated receive power as perceived by the MS;

P_{Tx} is the transmit power as defined by the AP;

L_{P} is the path loss;

I_{MP} is the multipath induced interference;

I_{OC} is the interference induced by adjacent transmitting devices; and

N₀ is the thermal noise.

Taking into account that the multipath interference is proportional to the transmit power 202 as defined by the AP 102; the total received power 206 becomes a function of the transmit power 202 and environmental interference 208:

P_{Rx}=P_{Tx}×(L_{P}+L_{MP})+(I_{OC}+N₀) or

P_{Rx}=P_{Tx}×L_{T}+I

where:

P_{Rx} is the total estimated receive power as perceived by the MS;

P_{Tx} is the transmit power as defined by the AP;

L_{P} is the path loss;

L_{MP} is the multipath path loss;

I_{OC} is interference induced by adjacent transmitting devices;

N₀ is the thermal noise;

L_{T} is the total path loss; and

I is the total interference as perceived by the MS.

Given that the link is time division multiplexed between multiple users, a continuous scan of the communication link 106 yields the total interference, I, by monitoring the lowest absolute receive power 206 as perceived by the MS 104 over time.

I=minₜᵢₘₑ_{_{—}}ᵢₙₜₑᵣᵥₐₗ(P_{RX})

The total interference, I, is the power received by the MS 104 when the AP 102 and all other MSs in communication with the MS 104 are silent (i.e., the quiet period). In the preferred embodiment, the AP may optionally schedule at least one quiet period where all the devices are required to be silent and measure their local interference level.

Once the total interference, I, is known, the MS 104 can deduce the communication link 106, L_{T}, by the following equation:

$${L}_{T} = \frac{{P}_{Rx} - I}{{P}_{Tx}}$$

Knowing the communication link 106, L_{T}, is not sufficient for the MS 104 to define the correct transmit power 212 for the response message because the interference 204 perceived by the AP 102 may be different than the interference 208 perceived by the MS 104. To overcome the discrepancy in perceived interference levels, the AP 102 transmits its perceived local interference level 204 to the MS 104.

Knowing the communication link, L_{T}, the MS 104 estimates the optimal data rate by any appropriate method, and using the optimal data rate, deduces a target SNR at the AP 102 for the response message. Once the SNR is known, the MS 104 can calculate the required transmit power 212 for the response message using the following equation:

$${SnR}_{Target} = \frac{{P}_{MTx} \times {L}_{T}}{{I}_{AP}} or$$

$${P}_{MTx} = \frac{{SnR}_{Target} \times {I}_{AP}}{{L}_{T}}$$

where:

P_{MTx} is the total transmitted power at the MS;

L_{T} is the total path loss;

I_{AP} is the interference at the AP; and

SnR_{Target} is the required signal to noise ratio at the AP for a given transmission rate.

When moved to dB notations, the equation reads:

P_{MTx}(dB)=SnR_{Target}(dB)+I_{AP}(dB)−L_{T}(dB)

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A method comprising the steps of:
at a first device,
receiving a first message from a second device over a communication link;
determining a first transmit power level at which the first message was transmitted;
determining a first interference level as perceived by the second device; and
calculating at least one transmission parameter by which a second message will be transmitted to the second device based on the first transmit power level and the first interference level.

2. The method of claim 1 wherein at least one of the first transmit power level and the first interference level is a part of the first message.

3. The method of claim 1 further comprising the step of measuring a second interference level as perceived by the first device.

4. The method of claim 3 wherein the second interference level is measured during a quiet period.

5. The method of claim 4 wherein the quiet period is identified by monitoring the communication link.

6. The method of claim 4 wherein the quiet period is scheduled by at least one of the first device and the second device.

7. The method of claim 3 wherein the step of calculating is further based on the second interference level.

8. The method of claim 3 further comprising the step of transmitting the second interference level to the second device from the first device.

9. The method of claim 1 wherein the at least one optimal transmission parameter is selected from a group consisting of: transmit power, data rate, modulation format, modulation mode, spreading, coding, and error correction.

10. The method of claim 1 wherein the step of calculating is further based on channel attenuation of the communication link.

11. The method of claim 1 further comprising the step of transmitting the second message to the second device using the at least one transmission parameter.

12. The method of claim 11 further comprising transmitting a second transmit power level to the second device by which the second message was transmitted.

13. The method of claim 1 wherein the step of calculating comprises deducing a link path loss.

14. The method of claim 1 wherein the communication link is a wireless communication link.

15. The method of claim 1 wherein the communication link is a wired communication link.

16. The method of claim 1 wherein the first message is training pattern.

17. The method of claim 1 wherein at least one of the steps of determining comprises the step of receiving the level via one of the first message and a third message.

18. The method of claim 1 further comprising the step of estimating a receive power level of the first message at the first device.

19. An apparatus comprising:
a receiver for receiving a first message from a device over a communication link;
a modem, coupled to the receiver, for determining a first transmit power level at which the first message was transmitted and for determining a first interference level as perceived by the device; and
a processor, coupled to the receiver and the modem, for calculating at least one transmission parameter by which a second message will be transmitted to the device based on the first transmit power level and the first interference level.

20. The apparatus of claim 19 further comprising a power meter, coupled to the receiver and the processor, for estimating a receive power level of the first message and for estimating a second interference level as perceived by the apparatus.

21. The apparatus of claim 19 further comprising a transmitter, coupled to the processor, for transmitting the second message to the device using the at least one transmission parameter.
